(19) United States
(12) Patent Application Publication
(10) Pub. No.: US 2013/0245860 A1
(43) Pub. Date: Sep. 19, 2013

(54) SITUATIONAL AWARENESS PILOT BRIEFING TOOL

(71) Applicant: GE AVIATION SYSTEMS LIMITED, Cheltenham (GB)

(72) Inventor: Jennifer COOPER, Gloucestershire (GB)

(73) Assignee: GE AVIATION SYSTEMS LIMITED, Cheltenham (GB)

(21) Appl. No.: 13/784,918

(22) Filed: Mar. 5, 2013

(30) Foreign Application Priority Data
Mar. 19, 2012 (GB) 1204793.2

(51) Int. Cl. B64D 45/00

(52) U.S. Cl. CPC B64D 45/00
USPC 701/14

(57) ABSTRACT

Embodiments of the present invention relate to a system and method for better conveying information to a pilot and/or other members of a flight crew present on the flight deck of an aircraft. Embodiments of the invention are of particular use in the briefings that precede various phases of the flight operations of an aircraft (such as start-up of the engines, take-off, ascent to cruise altitude, descent from cruise altitude and landing). The system and method provide a briefing output relevant to the particular phases of a flight in both of a visual form and an audio form, with the briefing output including data of most relevance to the particular flight phase.

### BACKGROUND OF THE INVENTION

The present invention relates to a system and method for better conveying information to a pilot and/or other members of a flight crew present on the flight deck of an aircraft. The invention is of particular use in the briefings that precede various phases of the flight operations of an aircraft (such as start-up of the engines, take-off, ascent to cruise altitude, descent from cruise altitude and landing).

Airline Standard Operating Procedures (SOP's) identify and describe the standard tasks and duties of an aircraft's flight crew for each phase of a flight, including what to do and when to do it. One of the requirements laid down in the SOP's are briefings to be given by one member of the flight crew to the other crew members. Typically, the briefing is given by the captain. The purpose of each briefing is to ensure that all of the flight crew possess a common and complete understanding of their respective responsibilities and what will be happening at particular stages of the flight. The briefings allow for any inconsistencies in understanding between crew members to be discovered and resolved before the relevant point in the flight, thereby ensuring that the crew are acting in a coordinated manner and not at cross-purposes. In this way, the briefings perform an essential role in ensuring the safe operation of an aircraft during all stages of its flight.

By way of example, briefings would be performed covering the phases of an aircraft's flight such as take-off, ascent to cruise altitude, cruise and descent/landing. The briefings would run through the actions expected of the crew members for each phase of the flight and also convey information relevant to the particular phase of the flight. By way of example, in the case of the briefing for take-off the briefing may include i) instrument settings such as such as control settings for throttle and flaps, ii) defined speeds such as V1 (this being the maximum speed during take-off at which a pilot can safely abort the take-off and stop the aircraft without leaving the runway, as well as the minimum speed that allows the pilot to safely continue to take-off even if a critical engine failure occurs), iii) V2 (this being the safe take-off speed), iv) the taxiing route to the runway for take-off, and iv) runway length. Following take-off, subsequent briefings would then cover navigational aspects, such as outlining navigational waypoints along the cruise flight path and any changes in course and consequent control settings required to enable the aircraft to reach these waypoints, as well as any programmed autopilot settings. Prior to descent for landing, a briefing would also be performed outlining respective responsibilities of the crew members for descent and landing, and detailing elements such as when to deploy the landing gear, approach speed for landing appropriate to the runway at the destination airport, and appropriate control settings such as those for throttle and flaps.

However, the briefing process is time consuming and is dependent upon one of the flight crew giving the briefing, thereby necessarily limiting the respective crew member's ability to undertake other tasks. There is therefore a need for improving the briefing process so that less of a burden is placed on the person conventionally responsible for giving such briefings.

The current nature of these briefings also represents a significant obstacle to the introduction of single person flight operations for commercial aircraft. By “single person flight operations” is meant where the flight crew consists of a single pilot only. In such a case, the traditional briefing format would present significant risks to the safety of an aircraft during its flight, with there being no-one present with which the single pilot can confirm the actions required for each stage of the flight. There is therefore a need for means capable of permitting single person flight operations for commercial aircraft without compromising safety.

### BRIEF DESCRIPTION OF THE INVENTION

An embodiment of the present invention providing a situational awareness briefing system for a flight crew of an aircraft, wherein the system is operable to interrogate data from a plurality of sources is disclosed. The system comprises a selection filter for filtering the interrogated data to provide a selected subset of the interrogated data relevant to one or more parts of a flight of the aircraft and a multisensory output device for providing a briefing output based upon the selected subset of the interrogated data. The briefing output comprises at least two of actions required of the flight crew relevant to the one or more parts of the flight; settings of aircraft on-board systems relevant to the one or more parts of the flight; and information provided by one or more information sources off-board the aircraft relevant to one or more parts of a flight of the aircraft. The multisensory output device is operable to provide all or part of the briefing output in both a visual form to provide a visual simulation, confirmation or representation of the actions, settings or information, and an audio form to provide an auditory simulation, confirmation or representation of the actions, settings or information.

An embodiment of the present invention provides a method for providing a situational awareness briefing to a flight crew of an aircraft. The method comprises interrogating data from a plurality of sources, filtering the interrogated data to form a selected subset of the interrogated data relevant to one or more parts of a flight of the aircraft, and providing a multisensory briefing output based upon the selected subset of the interrogated data. The briefing output comprising at least two of actions required of the flight crew relevant to the one or more parts of the flight; settings of aircraft on-board systems relevant to the one or more parts of the flight; and information provided by one or more information sources off-board the aircraft relevant to the one or more parts of the flight. The briefing output is provided in both: a visual form to provide a visual simulation, confirmation or representation of the actions, settings or information, and an audio form to provide an auditory simulation, confirmation or representation of the actions, settings or information.

### BRIEF DESCRIPTION OF DRAWINGS

Embodiments of the present invention are described with reference to the following accompanying drawings:

FIG. 1 shows a situational awareness briefing system according to an embodiment of the invention;

FIG. 2 shows a multisensory output device according to an embodiment of the invention;

FIG. 3 shows a multisensory output device according to an embodiment of the invention;

FIG. 4 shows a multisensory output device according to an embodiment of the invention; and

FIG. 5 shows a multisensory output device according to an embodiment of the invention.

### DETAILED DESCRIPTION OF THE INVENTION

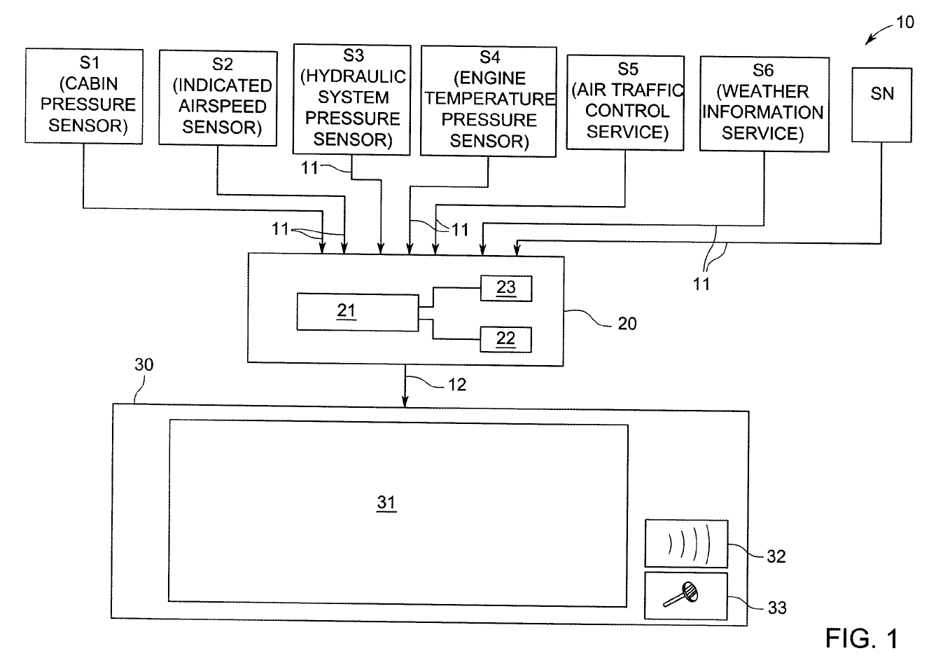

FIG. 1 shows a situational awareness briefing system 10 according to an embodiment of the invention. The system 10 is for use with an aircraft (not shown). The system 10 interfaces with a plurality of data sources S1, S2, S3 . . . SN, where N indicates the number of data sources. In the embodiment shown in FIG. 1, source 51 is a cabin pressure sensor, source S2 is an indicated air speed sensor, source S3 is a hydraulic system pressure sensor, source S4 is an engine temperature sensor, source S5 is an air traffic control service relating to a landing destination for the aircraft and source S6 is a weather information service for providing weather information relating to the landing destination. Sources S1 to S4 are on-board the aircraft and sources S5 and S6 are off-board the aircraft. The system is capable of interfacing with many other sources of data both on- and off-board the aircraft in addition to those shown, such as instrument sensors for aircraft altitude, attitude and control surface settings. Data 11 from the various sources S1 . . . SN is fed into a selection filter 20, which includes a computer processor 21. One or more memory modules 22 and one or more data storage modules 23 interface with the computer processor 21. The processor 21 operates according to an algorithm to interrogate the data received 11 from all of the sources S1 . . . SN and filters the data according to the algorithm to provide a selected subset 12 of the interrogated data relevant to a particular part of a flight for the aircraft. For the purpose of this embodiment, the “flight” is from a first destination airport A to a second destination airport B.

The selected subset 12 of interrogated data is provided from the selection filter 20 to a multisensory output device 30 to provide a briefing output. For the embodiment indicated in the drawings, the multisensory output device 30 is shown as including a touch sensitive display screen 31 to provide a visual output and a speaker 32 to provide an audio output. In this manner, the briefing output is provided in both of a video form and an audio form. In other embodiments, the audio output could include an audio feed into headsets/earpieces worn by the flight crew. Further, although the multisensory output device 30 is shown as including only a single display screen, in other embodiments it may include two or more distinct display screens and/or a head-up/-down/-mounted display viewable to one or more members of the flight crew.

The system 10 also includes a microphone 33 to allow the flight crew to provide audio input to the system. In other embodiments, the microphone 33 may be integral to headsets worn by the flight crew. The use of the touch sensitive display screen 31 provides an interface to allow kinaesthetic input signals to the system 10 by the flight crew; for example, by a crew member passing their finger (or other pointer tool) over the screen. In this manner, the system allows for the flight crew to make inputs to the system 10 by two distinct means—audio (via the microphone 33) and kinaesthetic (via the touch sensitive display screen 31). Examples of these inputs and the briefing output will be described in more detail below.

The system 10 may be used to provide briefings to the flight crew covering distinct parts of the flight, such as take-off, ascent to cruise altitude, cruise, descent and landing. When used in this manner, the briefing output (in both its visual and audio form) outlines all of: actions required of the flight crew relevant to the distinct part of the flight (for example, navigation course changes and extending/retracting the undercarriage); settings required of aircraft on-board systems relevant to the distinct part of the flight (for example, particular settings required for the control surfaces of the aircraft, engine throttle settings); information provided by one or more information sources off-board the aircraft relevant to the flight (for example, climatic conditions expected to be encountered along the flight path as notified by the Weather Information Service, delays expected to be encountered along the flight path as notified by Air Traffic Control).

In use, the system is able to provide the briefing output in two distinct forms—visual and audio.

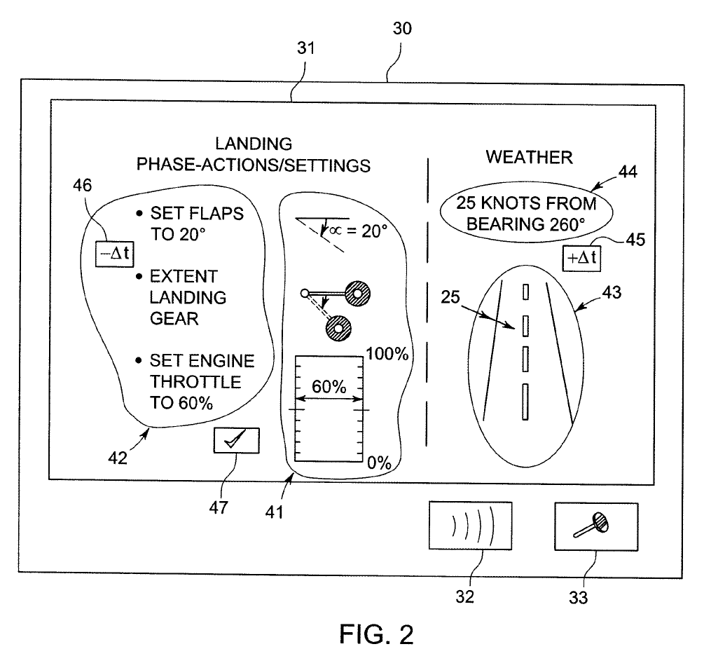

FIG. 2 shows a detail view of the multisensory output device 30 when used to provide a briefing output relevant to the descent and landing phase of the flight. FIG. 2 shows the display screen 31 providing visual output of the actions/settings relevant to the descent/landing phase in two distinct forms—pictorially and textually. FIG. 2 shows pictorial 41 and textual 42 representations of the flap settings, landing gear position and throttle settings relevant to the descent and landing phase. Additionally, FIG. 2 also shows pictorial 43 and textual 44 representations showing the direction and strength of winds across a destination runway—this data having been acquired from the Weather Information Service (data source S6 in FIG. 1). In an embodiment, the system 10 is configured to provide a real-time output of the weather conditions at one or more given geographical locations. An audio output of one or more parts of the information displayed visually is provided via the speaker 32. In this manner, the briefing output is provided in both of an audio and a visual form, with the visual form having both pictorial (41, 43) and textual elements (42, 44).

As shown in FIG. 2, the touch sensitive display screen 31 of the multisensory output device includes icons 45, 46 for progressing forwards and backwards in time to different parts of the briefing output. Additionally, to provide an assurance that the flight crew have properly understood and processed each portion of the briefing output, the screen 31 also includes an acknowledgement icon 47 which one or each of the flight crew must touch to provide an acknowledgement input signal required for the system 10 to progress to the next portion of the briefing output relevant to that part of the flight.

In an embodiment, the flight crew may make input signals to the system 10 orally via the microphone 33.

The input signals may be in the form of acknowledgment input signals (as indicated in the paragraph above) or can be command input signals to control the briefing output from the system 10 and/or to perform actions on the aircraft itself.

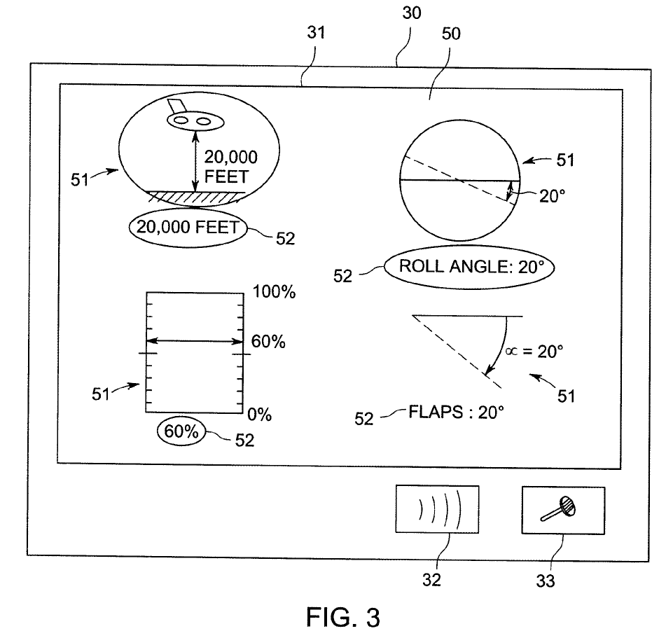

FIG. 3 shows an alternative view of the multisensory output device 30, with the display screen 31 providing a reduced cockpit instrument panel 50. The reduced cockpit instrument panel 50 is shown as including pictorial and textual representations 51, 52 of altitude, attitude, engine throttle and flaps relevant to a particular part of the flight. This may be accompanied by an audio output via speaker 32 of all or part of the information shown visually. The reduced cockpit instrument panel 50 may form part of the briefing undertaken before the particular part of the flight. Alternatively, it can provide a real-time output corresponding to the current state of the aircraft, thereby providing the flight crew with information most critical to a current portion of the flight.

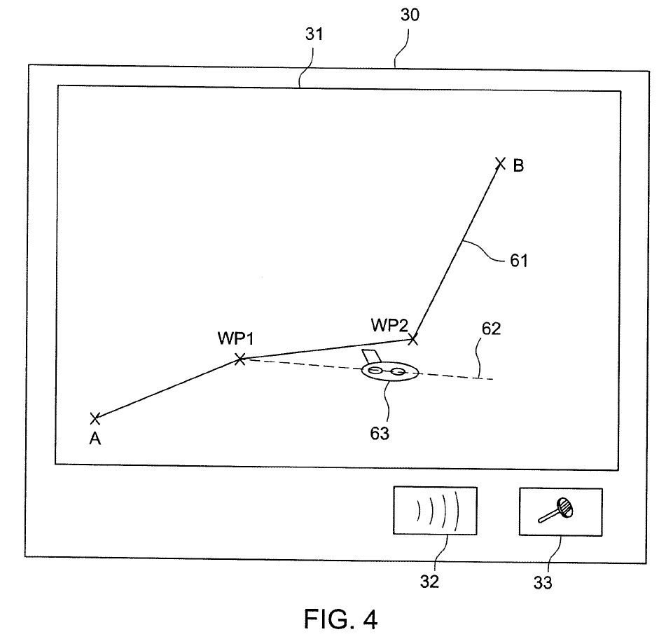

FIG. 4 shows an alternative view of the multisensory output device 30 when used to provide a warning of a deviation of the aircraft from a planned flight path. The display screen 31 shows the planned flight path as solid line 61 and the deviation of the aircraft from the planned flight path as dashed line 62. A pictorial representation 63 of the aircraft is used. Different colours may also be used to help distinguish between the planned flight path 61 and the deviation 62 from the planned flight path, thereby helping to draw the flight crew's attention to any deviation. Additionally, an audio warning may be provided via speaker 32 warning of the deviation 62 from the planned flight path 61. The visual display on the display screen also indicates relative geographical positions of different navigational waypoints WP1, WP2 along the flight path 61.

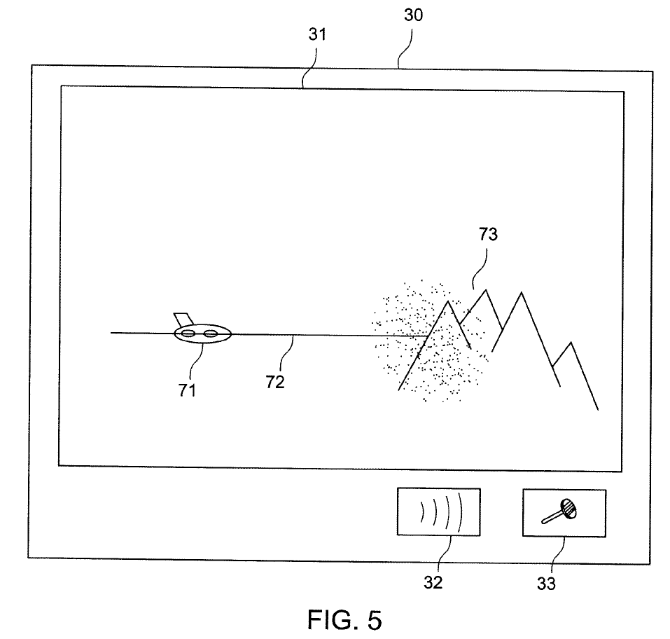

FIG. 5 shows a further alternative view of the multisensory output device 30 when used to provide a warning of a collision hazard to the aircraft. The display screen 31 shows a pictorial representation 71 of the aircraft, its current flight path 72 and the collision hazard 73. In the embodiment shown, the collision hazard 73 is a mountain range. However, the concept is equally applicable to collision hazards in the form of other aircraft. Again, colour coding may be used to draw the flight crew's attention to the collision hazard. Additionally, an audio warning may be provided via speaker 32 warning of the collision hazard.

Although the invention is shown as including a single display screen, embodiments of the invention may include two or more display screens conveying different information. In an embodiment where a multiscreen configuration is used, the reduced cockpit instrument panel (an example of which is shown in FIG. 3) may include displays relevant to the then current part of the flight.

In an embodiment of the present invention, the method of the invention may be put into practice through the various features of the situational awareness briefing system as outlined herein, but without being limited thereto.

The plurality of sources may include sources on-board and off-board the aircraft. Examples of on-board sources include, without limitation, sensors linked to essential aircraft systems (for example, engines, hydraulic systems, cabin environmental systems, altimeter, attitude sensor(s)) to provide readings of safety and/or performance parameters such as pressure, temperature, voltage, current, indicated aircraft speed (IAS), altitude and attitude; navigational systems providing data on current and destination locations, and navigational waypoints of relevance to the flight; mapping systems providing data on, for example, terrain relevant to the flight path, and geographical data relevant to a given airport, such as the navigational bearing and length of runways, maps of the airport showing gate locations and taxiways between the gate locations and the runways; and integrated health management services and flight management systems as well as warning & caution systems for providing warnings of faults and potential/actual hazards to the aircraft or its systems.

Examples of off-board sources (i.e. information sources off-board the aircraft) include, without limitation, weather information services providing the flight crew with data on climatic conditions expected to be encountered in-flight and at current and destination locations; and air traffic control services.

As indicated above, information acquired from these off-board sources may also form part of the briefing output. This may include, for example, providing the flight crew with real-time updates on climatic conditions (such as turbulence) expected to be encountered during the flight, or at critical locations of the flight such as take-off and landing and providing the flight crew with information from air traffic control on delays to any part of the flight.

In an embodiment, it is possible that there is interaction between some of the on-board and off-board sources. For example, the navigational systems are can interface with data provided by the weather information services. Additionally, the mapping systems may also be operable to interface with off-board sources such as air traffic control, thereby providing assurance that the mapping system is using the most up-to-date data relevant to a given geographical location.

In an embodiment, the briefing system is able to feed into a large number of sources containing data relevant to enabling the safe and efficient operation of the aircraft for a given flight.

The term “flight” is meant to define a journey between a first airport and a second airport. The term “flight crew” is meant to define the individual persons present in the cockpit of an aircraft responsible for piloting or assisting in the piloting of the aircraft, such as the pilot, co-pilot and first engineer.

In an embodiment, the selection filter incorporates one or more algorithms implemented by means of a computer processor, and serving to filter and select certain of the interrogated data by prioritising its relevance to particular parts of the flight. The selection filter provides the advantage of ensuring that the system is able to provide the flight crew with safety, navigational and operational information of most relevance to a particular part of the flight. This thereby helps to ensure that each member of the flight crew has an enhanced understanding of the actions required of them, the settings required for aircraft on-board systems, as well as relevant information from off-board the aircraft (such as notification of climatic conditions or flight delays) to ensure safe and efficient completion of the given part of the flight.

In an embodiment of the present invention, the multisensory output device provides an efficient means of providing the selected subset of the interrogated data from the selection filter to the flight crew in a way which maximizes the crew's understanding of the data, without presenting the flight crew with unnecessary data. Further, the ability of the system to provide a briefing output in both a visual and audio form helps to convey information to the flight crew in two distinct formats corresponding to different senses of the human body—namely vision and hearing. This thereby provides two separate channels through which information contained in the briefing output can be provided to and understood by the flight crew—visual and audible. The system is thereby able to cater for the fact that different people are better at processing information conveyed to them in different formats—some people are better at understanding, retaining and recalling information conveyed to them in a visual form and others are better at understanding, retaining and recalling information conveyed to them in an audio form. The system of the present invention thereby enhances the safe operation of an aircraft as it is better able to provide the flight crew with information of most relevance to a particular part of the flight and does so by providing that information in multiple formats. In this way, the system of the invention provides a briefing tool which is more effective at ensuring that all members of the flight crew have a full understanding of their respective responsibilities. Additionally, the functionality of the system means that it is able to perform the briefing role that is conventionally performed by one or more members of the flight crew. In this manner, the system of the present invention provides a tool which could enable single pilot operations for commercial aircraft to be undertaken safely and efficiently—in this case, the “flight crew” would be a single person—a pilot.

In an embodiment, the system is operable to request an acknowledgement input signal from the flight crew confirming their understanding of a first portion of the briefing output before permitting the system to progress onto subsequent portions of the briefing output. This aspect of the invention is of particular use for single pilot operations because it requires confirmation from the pilot before the system progresses to the next part of the briefing output, thereby providing assurance that the pilot has processed and understood the information provided in the first portion of the briefing output.

In an embodiment, the system comprises an interface operable to permit either or both of auditory and kinaesthetic input signals to the system by the flight crew. This embodiment of the invention also takes account of the fact that different individuals prefer to interact with systems in different ways. The input signals may be in the form of an acknowledgement of the flight crew confirming their receipt and understanding of portions of the briefing output (as outlined in the preceding paragraph). Alternatively, the input signals may be in the form of one or more commands to control the system (for example, to access a menu allowing access to briefing output for different parts of the flight, or to navigate back and forth between different parts of the briefing output), or to view and/or control instrument settings of the aircraft itself.

In an embodiment, the system may include one or more of a joystick, touch pad, mouse and buttons to enable the flight crew to provide the kinaesthetic input signals to interact with the system. These means of kinaesthetic interaction would drive a cursor to facilitate control of the system.

In an embodiment, the multisensory output device and the interface are provided as a common display screen, the display screen being touch sensitive. In this way, a common means—the display screen—is able to both provide the briefing output from the system to the flight crew and serve as means for providing inputs to the system. The use of a touch sensitive screen enables kinaesthetic inputs to be made to the system, for example, by passing a finger, or a pen or other pointer tool over the screen.

In an embodiment, the system is operable to provide the briefing output as comprising simultaneous textual and pictorial representations of one or more of the actions, settings and information of the briefing output. This embodiment of the invention breaks down the visual representation of the briefing output into two distinct forms—pictorial and textual—and recognizes that different people are able to process and understand information better when presented in particular forms. By providing both textual and pictorial representations simultaneously, the invention is able to satisfy the needs of both those people who are more efficient at processing and understanding visual information presented pictorially, and those people who are more efficient at processing and understanding visual information presented textually. By way of example, this embodiment of the invention could be applied to the throttle settings required for a given part of an aircraft's flight by a pictorial representation of the throttle setting including a color coded sliding scale, with the position of a pointer along the scale indicating the throttle setting as a percentage of maximum thrust, with the arrow being colored predominantly red towards 100% thrust and colored predominantly blue towards 0% thrust; and a textual representation of the throttle setting being in the form of a numerical readout of the throttle setting expressed as a percentage of maximum thrust.

In an embodiment, the textual representation may itself include color coding of text. Color coding may be used to provide an indication of the relative priority of the actions, settings or information being displayed, or to differentiate between different systems of the aircraft (such as engines, hydraulics, cabin environmentals).

In an embodiment, the briefing output is provided as an audio-visual output navigable by the flight crew forwards and backwards in time to provide a simulation of one or more parts of the flight and planned behavior of the aircraft. To further enhance the flight crew's understanding of the briefing output, the briefing output may be provided in a three-dimensional visual form. Such a three-dimensional visual form may be provided by means of an adapted headset, or glasses worn by the flight crew, or a system of one or more projectors disposed within the cockpit and presenting a three-dimensional image. A three-dimensional representation would provide enhanced spatial awareness. By way of example, a three-dimensional representation would be particularly useful when providing a visual representation of the aircraft's location relative to other aircraft or terrain hazards (such as mountains).

In an embodiment, the system is operable to provide the briefing output as comprising one or more of a warning of a deviation of the aircraft from a planned flight path, the warning comprising providing a pictorial representation of the deviation of the aircraft from a planned flight path accompanied by an audio warning of the deviation of the aircraft from the planned flight path; and a warning of a collision hazard, the warning comprising providing a pictorial representation of the collision hazard accompanied by an audio warning of the collision hazard.

The above aspect of the invention can be used in-flight to provide the flight crew with a real-time warning briefing of where aircraft settings or external influences (for example, higher than expected wind speeds) may lead to a deviation of the aircraft from a planned flight path or where there is a collision threat (for example, with other aircraft or the ground).

In an embodiment, color coding is also used to indicate the deviation from the planned flight path, for example, showing the planned flight path in a first color and the deviating flight path in a second color. However, color coding can also be applied more generally to the visual form of the briefing output, to help provide visual emphasis to one or more parts of the briefing output in the same or similar manner as indicated earlier for the textual representation.

In an embodiment, the system is operable to provide the briefing output as comprising a pictorial representation of the aircraft in flight and either or both of a pictorial representation and a textual representation of one or more of the actions, settings or information of the briefing output. For example, the pictorial representation of the aircraft may include visual indications of the settings for the control surfaces (for example, ailerons, flaps and rudder of the aircraft) and engine throttle.

In an embodiment, the system is operable to provide the briefing output as comprising a pictorial representation of a reduced cockpit instrument panel, the reduced cockpit instrument panel providing either or both of a pictorial representation and a textual representation of settings of selected aircraft on-board systems appropriate to the one or more parts of the flight. This embodiment of the invention provides the advantage of allowing the flight crew to be provided with a summary of the settings of aircraft on-board systems which are of most relevance to the particular part of the flight, and excluding those which are of less relevance. For example, for the descent and landing part of the flight, the reduced cockpit instrument panel may include those corresponding parts of the actual cockpit display indicating settings for the control surfaces (especially the flaps), status of the undercarriage, altitude and attitude of the aircraft, and throttle settings for the engines.

In an embodiment, the system comprises one or more of a head-up display, head-down display and a head-mounted display. These head-up, head-down and/or head-mounted display(s) may be the sole means of providing the visual form of the briefing output or may coexist alongside one or more display screens.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A situational awareness briefing system for a flight crew of an aircraft, wherein the system is operable to interrogate data from a plurality of sources, wherein the system comprises:
a selection filter for filtering the interrogated data to provide a selected subset of the interrogated data relevant to at least one part of a flight of the aircraft;
a multisensory output device for providing a briefing output based upon the selected subset of the interrogated data, the briefing output comprising at least two of actions required of the flight crew relevant to the at least one part of the flight; settings of aircraft on-board systems relevant to the at least one part of the flight; and information provided by at least one information source off-board the aircraft relevant to the at least one part of the flight;
wherein the multisensory output device is operable to provide at least a part of the briefing output in both
a visual form to provide a visual simulation, confirmation or representation of the actions, settings or information, and
an audio form to provide an auditory simulation, confirmation or representation of the actions, settings or information.

2. A situational awareness briefing system according to claim 1, wherein the system is operable to request an acknowledgement input signal from the flight crew confirming their understanding of a first portion of the briefing output before permitting the system to progress onto subsequent portions of the briefing output.

3. A situational awareness briefing system according to claim 1, wherein the system comprises an interface operable to permit at least one of auditory and kinaesthetic input signals to the system by the flight crew.

4. A situational awareness briefing system according to claim 3, wherein the interface comprises a touch sensitive display screen.

5. A situational awareness briefing system according to claim 3, wherein the multisensory output device and the interface are provided as a common display screen, wherein the display screen is touch sensitive.

6. A situational awareness briefing system according to claim 1, wherein the system is operable to provide the briefing output as comprising simultaneous textual and pictorial representations of at least one of the actions, settings and information.

7. A situational awareness briefing system according to claim 1, wherein the system is operable to provide the briefing output as comprising at least one of a warning of a deviation of the aircraft from a planned flight path, the warning comprising a pictorial representation of the deviation of the aircraft from a planned flight path accompanied by an audio warning of the deviation of the aircraft from the planned flight path; and a warning of a collision hazard, the warning comprising a pictorial representation of the collision hazard accompanied by an audio warning of the collision hazard.

8. A situational awareness briefing system according to claim 1, wherein the system is operable to provide the briefing output as comprising a pictorial representation of the aircraft in flight and at least one of a pictorial representation and a textual representation of at least one of the actions, settings and information of the briefing output.

9. A situational awareness briefing system according to claim 1, wherein the system is operable to provide the briefing output as comprising a pictorial representation of a reduced cockpit instrument panel, the reduced cockpit instrument panel providing at least one of a pictorial representation and a textual representation of settings of selected aircraft on-board systems appropriate to the at least one part of the flight.

10. A situational awareness briefing system according to claim 1, wherein the multisensory output device is operable to provide at least one part of the visual form of the briefing output in a three-dimensional visual form.

11. A situational awareness briefing system according to claim 1, wherein the system comprises at least one of a head-up display, a head-down display, and a head-mounted display.

12. A method for providing a situational awareness briefing to a flight crew of an aircraft, the method comprising:
interrogating data from a plurality of sources;
filtering the interrogated data to form a selected subset of the interrogated data relevant to at least one part of a flight of the aircraft; and
providing a multisensory briefing output based upon the selected subset of the interrogated data, the briefing output comprising at least two of actions required of the flight crew relevant to the at least one part of the flight; settings of aircraft on-board systems relevant to the at least one part of the flight; and information provided by at least one information source off-board the aircraft relevant to the at least one part of the flight;
wherein the briefing output is provided in both
a visual form to provide a visual simulation, confirmation or representation of the actions, settings or information, and
an audio form to provide an auditory simulation, confirmation or representation of the actions, settings or information.

13. A method according to claim 12, further comprising requesting an acknowledgement input signal from the flight crew confirming their understanding of a first portion of the briefing output before progressing onto subsequent portions of the briefing output.

14. A method according to claim 12, wherein the briefing output comprises simultaneous textual and pictorial representations of at least one of the actions, settings and information.

15. A method according to claim 12, wherein the briefing output comprises at least one of a warning of a deviation of the aircraft from a planned flight path, the warning comprising a pictorial representation of the deviation of the aircraft from a planned flight path accompanied by an audio warning of the deviation of the aircraft from the planned flight path; and a warning of a collision hazard, the warning comprising a pictorial representation of the collision hazard accompanied by an audio warning of the collision hazard.

16. A method according to claim 12, wherein the briefing output comprises a pictorial representation of the aircraft in flight and at least one of a pictorial representation and a textual representation of at least one of the actions, settings and information.

17. A method according to claim 12, wherein the briefing output comprises a pictorial representation of a reduced cockpit instrument panel, the reduced cockpit instrument panel providing at least one of a pictorial representation and a textual representation of settings of selected aircraft on-board systems appropriate to the at least one part of the flight.

18. A method according to claim 12, wherein at least a part of the visual form of the briefing output is provided as comprising a three-dimensional visual form.
